(19) United States
(12) Patent Application Publication
(10) Pub. No.: US 2019/0345727 A1
(43) Pub. Date: Nov. 14, 2019

(54) CONSTRUCTIVE ARRANGEMENT INTRODUCED IN MACHINE ROOM FOR SWIMMING POOLS

(71) Applicant: Igui Worldwide Piscinas Ltda., Cedral (BR)

(72) Inventor: Luiz Filipe de Souza SISSON, Cedral (BR)

(21) Appl. No.: 15/977,583

(22) Filed: May 11, 2018

(51) Int. Cl. E04H 4/12; C02F 1/68

(52) U.S. Cl. CPC E04H 4/1245; C02F 2103/42; E04H 4/1281; C02F 1/685

(57) ABSTRACT

A system for the maintenance and cleaning of swimming pool water suitable for use in swimming pool machine rooms. The system comprises a rectangular body formed by an L-shaped region and a smaller rectangular region, wherein the “L”-region houses the heating motor and the filter motor at its rear, and having between them, located beneath a cover, a flood controller sensor. On the shorter side of the L-region is the chlorinator, which is connected at an end to a flow controller sensor. The smaller rectangular region, in turn, is split into a dry housing and a wet housing, the dry housing being where the swimming pool accessories activating valves are located, and the wet housing providing a location for a swimming pool water inlet opening, a first tubular recess for a water inlet control float and a second tubular recess for accommodating a cartridge filter.

### FIELD OF THE INVENTION

The present invention relates generally to swimming pool equipment, and in particular to a system for maintenance and cleaning of swimming pool water, suitable to be placed in the machine room of a swimming pool.

### BACKGROUND OF THE INVENTION

With the advent of fiberglass swimming pools, having a swimming pool at home has become a dream come true, and thus there is a continuous search for equipment and accessories to improve their use and provide added value to the product.

However, a swimming pool requires constant care and maintenance, which is an inconvenience due to the costs, such as that of products needed to keep the pool suitable for use, and a need for specialized professionals to perform maintenance tasks or alternatively the inconvenience to the owner himself, who most often takes care of the maintenance of the pool.

Thus, in parallel with improvements for use, there is also an incessant search for ways to preserve the proper functioning of pool equipment and to facilitate the work of the owner. In this way, several improvements have been made over time in relation to the machine room, where all of the equipment and accessories are usually found for preservation of the state of the pool water and cleaning of the water to make it appropriate for use.

Such improvements, limited to the inventions of the applicant, are known from the prior art, such as in Brazilian prior art documents MU8000413-0 relating to “Arrangement in swimming pools water cleaning system”; MU8400477-0 relating to “Arrangement introduced in swimming pools water cleaning equipment”; MU8601951-1 relating to “Equipment for filtering swimming pool water with ultraviolet ray device”; MU8900790-5 relating to “Multifunctional equipment for filtering swimming pool water” and BR202014015732-3 relating to “Construction arrangement applied in machine room for swimming pool”. All of these consisted of improvements developed over the years, according to the needs of the market.

What is needed therefore is any further developments allowing for more efficient or cost-effective maintenance and/or use of swimming pools.

### SUMMARY OF THE INVENTION

The present invention refers to a new system for the maintenance and cleaning of swimming pool water, and the provision of equipment necessary for facilitating the maintenance of such pools. This system is suitable for use in the machine rooms of swimming pools, wherefore advantageous practical, safe and functional results are obtained.

The system with its novel arrangement, allows a more efficient filtration of swimming pool water, via flow and flooding controllers of an electrical portion, and other advantages deriving from its design.

### BRIEF DESCRIPTION OF THE DRAWINGS

FIG. 1 is a perspective view of the new system for the maintenance and cleaning of swimming pool water.

FIG. 2 is a perspective view of the system for the maintenance and cleaning of swimming pool water, without its cover.

FIG. 3 is an exploded perspective view of the system for the maintenance and cleaning of swimming pool water.

FIG. 4 is a top view of the system for the maintenance and cleaning of swimming pool water.

FIG. 5 is an enlarged perspective view of the chlorinator.

### DETAILED DESCRIPTION OF THE INVENTION

The invention will be described for the purposes of illustration only in connection with certain embodiments; however it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

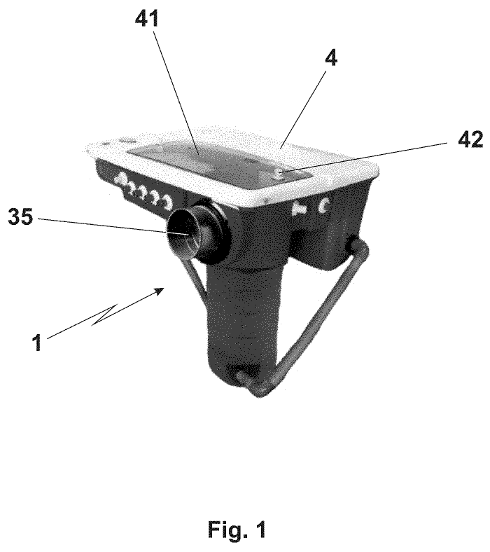

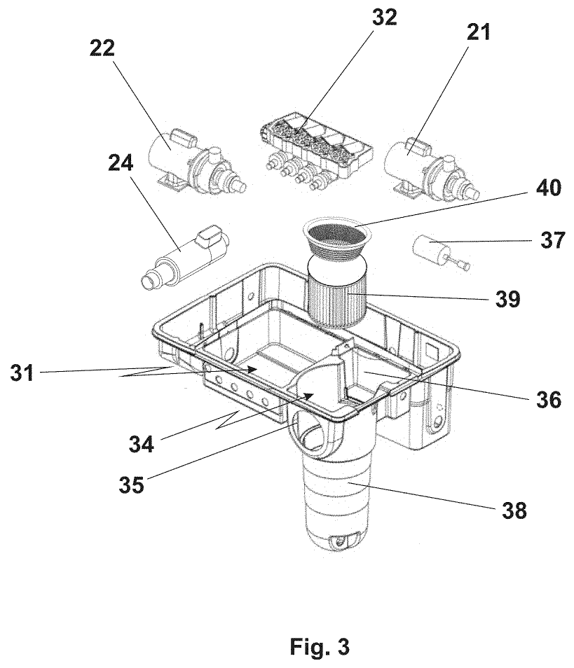

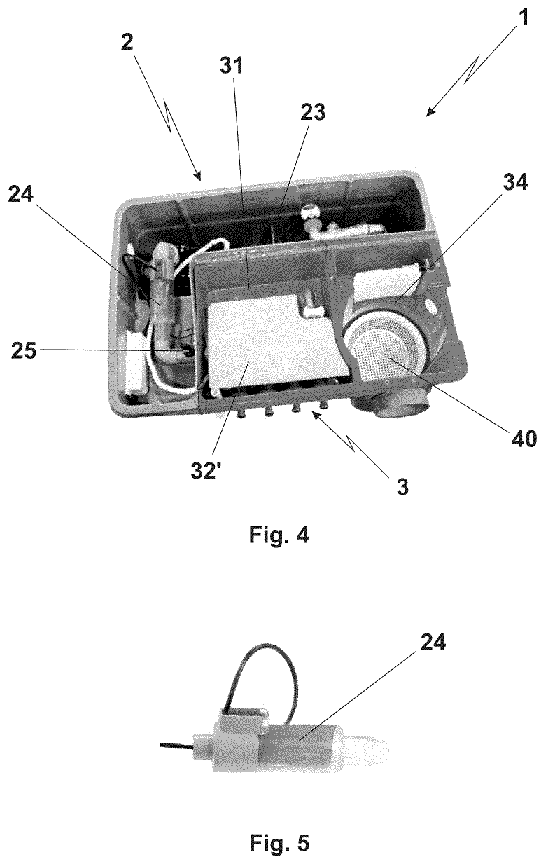

The present invention, as illustrated in FIGS. 1 to 4, includes a rectangular body (1) formed by an “L” region (2) and a smaller, rectangular region (3). The body is closed by a shielded rectangular cover (4) through screws, and having on the smaller rectangular region (3) a smaller cover (41), removable through locks (42).

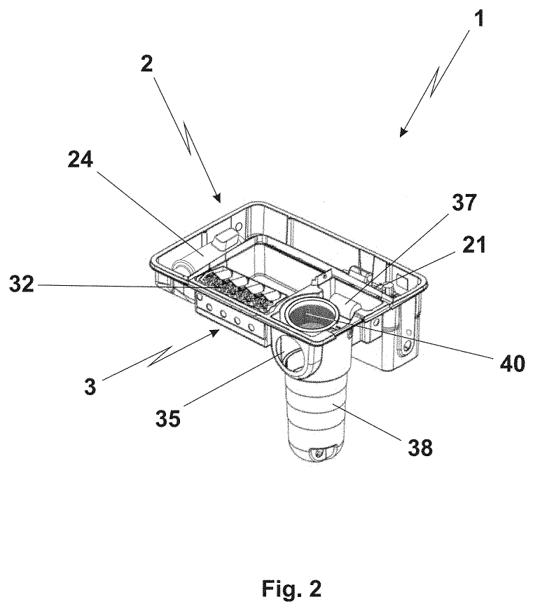

As illustrated in FIGS. 2 to 4, the “L” region (2) houses, in its upper part, the heating motor (21) and the filter motor (22), and between them is provided a flood controller sensor (not shown) located underneath an inside cover (23). The flood sensor issues a warning to the control panel of the electrical/electronic control cabinet. On the shorter side of the L-region, connected at one end to the filtering motor (22), is the chlorinator (24), which is responsible for the total chemical treatment. The chlorinator also has, provided at its other end, a flow control sensor (25), which when activated automatically turns off and emits a signal to the control panel of the electrical/electronic control cabinet.

The smaller rectangular region (3) is divided into two parts, forming a dry housing (31) where the pool accessories activating valves (32) are protected by a cover (32′), and a wet housing (34) having an opening for a swimming pool water inlet (35), a first tubular recess (36) for the water inlet control float (37) of a hydraulic net, and a second tubular recess (38) for accommodating the cartridge filter (39), on which is coupled a pre-filter (40).

With the system for the maintenance and cleaning of swimming pool water, the maintenance and use of a swimming pool becomes simpler, as all of the swimming pool equipment is found in a single place, with the heating and filter motors (21 and 22), the chlorinator (24) and the flood and flow sensors remaining in shielded, i.e. located within the “L”-region (2) on which the cover (4) is bolted. Yet in the accessible part, rectangular region (3), the user can remove the smaller cover (41), which is made removable through locks (42), therefore having access to the pre-filter (40) and cartridge filter (39) to maintain the swimming pool. In the event of flooding, the sensor located between the heating and filter motors (21) and (22) will emit a signal to the control panel, and in the case of water flow obstruction the flow control sensor (25) will also emit a signal.

The new system for the maintenance and cleaning of swimming pool water, as conceived, offers the following advantages in relation to its known similar ones:

automatic filtration using the chlorinator;

immediate information about possible flooding;

immediate information about any obstruction of the water flow;

greater efficiency in filtering with the use of a cartridge filter; and

shielding of equipment that does not need to be accessed frequently.

1. A system for maintaining and cleaning of swimming pool water, the system comprising:
(1) a rectangular body (1) comprising:
(a) an L-shaped region (2) comprising a heating motor (21) and a filter motor (22), the motors located beneath an inside cover (23), a flood control sensor for emitting a warning to a control panel of an electronic control cabinet, and a chlorinator (24) for chemical water treatment, the chlorinator connected at an end to the filter motor (22) and, at an opposite end, the chlorinator having a flow control sensor (25), wherein when activated, the flow control sensor automatically turning off and emitting a warning signal to the control panel of the electronic control cabinet, and
(b) a rectangular region (3), having a first cover (41), removable via a multiplicity of locks (42), the rectangular region comprising two housing sections, a dry housing (31) and a wet housing (34); the dry housing containing a multiplicity of pool accessory activation valves (32) protected by a cover (32′), and the wet housing (34) having an opening for a swimming pool water inlet (35) and a first tubular recess (36) for a water inlet control float (37) of a hydraulic net, the wet housing also having a second tubular recess (38), accommodating a cartridge filter (39), and the cartridge filter coupled to a pre-filter (40)
(2) an upper closure comprising a shielded rectangular second cover (4), attached to the rectangular body through screws.
